(19) United States
(12) Patent Application Publication
(10) Pub. No.: US 2019/0208766 A1
(43) Pub. Date: Jul. 11, 2019

(54) COMPOSITION FOR THE CONSERVATION/FIXATION OF BIOLOGICAL MATERIAL

(71) Applicants: Andrea FANTOZZI, Magliano de' Marsi (IT); Giovanni ARCUDI, Rome (IT)

(72) Inventors: Andrea FANTOZZI, Magliano de' Marsi (IT); Giovanni ARCUDI, Rome (IT)

(21) Appl. No.: 16/093,532

(22) PCT Filed: Apr. 12, 2017
(86) PCT No.: PCT/IB2017/052106

§ 371 Date: Oct. 12, 2018

(30) Foreign Application Priority Data
Apr. 12, 2016 (IT) 102016000037532

(51) Int. Cl. A01N 1/00; A01N 31/02; A01N 35/02

(52) U.S. Cl. CPC A01N 1/00; A01N 35/02; A01N 31/02

(57) ABSTRACT

This invention relates to a liquid-based composition consisting of a mixture of methylethylketone peroxide between 30 and 40%, Methylethylketone between 0 and 5%, hydrogen peroxide between 0 and 5%, diisobutrate of 1-Isopropyl-2,2-Dimethyltrimethylene between 40 and 50% and Diacetone alcohol between 5 and 10%, isobutyl alcohol and glycerol and its use for the fixation and/or conservation of organic material such as isolated organs and tissues, cells of animal or vegetable origin. The invention also relates to a method for the embalming of corpses comprising the injection of such composition into the blood and/or lymphatic vascular system of an animal or vegetable organism.

### THE TECHNICAL FIELD OF THE INVENTION

This invention relates to a composition based on methyl ethyl ketone peroxide (MEKP), isobutyl alcohol and glycerol and its use in fixation and/or preservation of organic/biological material intended as organs, tissues and cells of animal or vegetable origin. The invention also relates to a method of embalming, which involves injecting such composition in the blood and/or lymphatic vascular system of an animal or vegetable organism or any part of it.

### THE STATE OF THE TECHNIQUE (BACKGROUND)

Since prehistoric times people have tried to preserve the bodies of the deceased to prevent deterioration. The techniques mainly used the removal of viscera, dehydration of the body, corpse impregnation with resins and various substances. Historians are inclined to think that the study of the techniques of embalming had begun in Egypt but it was also practiced by the ancient Assyrians, Persians and Shiites. Perhaps the initial interest for embalming and the first experiments were due to the discovery of corpses buried in the desert sand and preserved in a natural way. This type of burial would prevent humidity and air from getting to the corpse, limiting thus the decomposition. Some speculate that they began to practice embalming when corpses preserved were found in natron (sodium carbonate decahydrate), alkaline salts which abounds in Egypt.

Modern embalming benefits, as well known, from the discovery of formaldehyde by the chemist August Wilhelm von Hofmann (1867). This substance, then evolved into formalin, supplanted the then used arsenic.

Currently, after the immersion in liquid bactericides, they solutions derived from the original formaldehyde are injected in the anatomical cavities of corpses using an appropriate pump. Formaldehyde solution is more commonly used for tissue preservation and especially for embalming, is an aqueous solution, available commercially called formalin containing 37-50% of formaldehyde and 10-15% methanol as a stabilizer. From the stock solution common use dilutions are obtained (5-10%).

In the health field it is used as a fixative/preservative of biological material and as a germicidal substance.

Although effective in the tissues fixation/preservation, formaldehyde has a number of disadvantages. In particular, it is irritating to ocular mucous and skin so much so that the occurrence of contact dermatitis is a risk ascertained for operators/technicians.

It has been reported that the formaldehyde at concentrations between 0.1 and 3 ppm causes irritation of the airways; for concentrations greater than 10 ppm sense of suffocation while exposures greater than 20 ppm can lead to pulmonary edema.

Furthermore, cases of asthma and respiratory impairment have been described in literature. In addition to these disadvantages different scientific studies conducted in experimental animals have demonstrated its potential carcinogenicity.

As for in humans, a recent review of the literature and the main Italian and international Oncology societies have shown that formaldehyde exposure increases the risk of onset of rhinopharyngeal and nasal cavity tumors and leukemias. Formaldehyde was, therefore, recognized as a carcinogen (carcinogenic 1/B classification by the European Commission through regulation 605/2014), it is irritating to the ocular and nasal mucous and skin; causes the onset of contact dermatitis, also, it is an ascertained occupational risk and falls within the art. 234 del D. Igs. 81/2008.

Even methyl alcohol, used as a stabilizer in the preparation of formalin, is known as a neurotoxin for both ingestion and inhalation of disperse vapours. Chronic exposure to aerial concentrations of vapors of methanol from 800-3000 ppm cause the buildup in the tissues with the formation of formic acid and subsequent metabolic acidosis and blindness. (cfr. Randall C. Baselt “Disposition of toxic drugs and chemicals in man”—Biomedical Publications Foster City (Calif.), 7 ed. 2004: 689-690)

The purpose of the present invention is to provide a composition for the fixation and/or preservation of organs, tissues, cells and organisms, alternative to those known. In addition, the purpose of this invention is to provide a solution which is not only effective but also devoid of the disadvantages described to the State of the the technique for units having the same finality, such as formaldehyde/formalin.

### SUMMARY OF THE INVENTION

The technical problem posed and solved by this invention is to provide, as stated above, a composition for fixation and/or for the preservation of organic/biological material alternative to formaldehyde and with an improved efficacy and safety profile over current formulations with similar aims.

The solution to the problem above is the use of composition for the fixation and/or preservation of organic/biological material as defined in claim 1.

A second objective of the invention is a method of embalming corpses comprising of a passage of injection in that corpse of composition of the invention as defined in claim 1.

A further objective of the invention is a process for the preparation of the composition here described as defined in claim 9.

Popular features of the present invention are the subject of dependent claims.

The composition described here is able to fix and/or maintain organic matter, such as isolated organs, tissues and cells of animal or vegetable origin, in an effective and comparable way to formaldehyde/formalin. The composition of the invention has been shown to have an improved safety profile than formaldehyde/formalin since none of the ingredients is placed on the 1-3 IARC lists of carcinogenic substances for humans, also, in experimental phases there was no irritating effect on the ocular mucous and on the skin for exposure to vapors or the onset of contact dermatitis in operators/technicians who handled the composition.

The composition, due to its effective fixation and/or preservation capacity of organic material and its low toxicity, is suitable for the application for the use in the cure of encoffining as well in areas such as forensic medicine, anatomy, pathological anatomy, criminology, biology, archeology, veterinary medicine, botany and, in general, in all those sectors where the preservation, fixation and preparation of organs, tissues or cells is required.

In summary, the composition of this invention combines technical properties and low toxicity which make it more beneficial than the compositions/substances currently known.

Other benefits, features and modalities of use of the invention will result obvious from the subsequent detailed description of some embodiments, presented for illustratives purpose without limitation.

### DETAILED DESCRIPTION OF THE PREFERRED FORMS OF REALIZATION

The following is a detailed description of various objects of the invention.

Composition

The composition described here, as stated above, it is appropriate to the fixation and/or preservation of biological/organic materials such as organs, tissues and cells of animal and/or vegetable origin. Preferably, the biological material is of human origin.

The composition includes as main active ingredient a solution consisting of methyl ethyl ketone peroxide also known as 2-butanone peroxide or MEK peroxide (MEKP) present in a percentage between 30 and 40%, methylethylketone between 0 and 5%, hydrogen peroxide between 0 and 5%, diisobutyrate by 1-Isopropyl-2.2-Dimethyltrimethylene between 40 and 50% and diacetone alcohol between 5 and 10%. The main ingredient is the ingredient present in the compositions in greater quantities. In particular, the quantity of the described solution in the composition is between 30% and 70% by volume of the composition.

The composition also includes iso-butyl alcohol and glycerine. In particular, glycerin is present in a percentage between 35% and 15% (in volume of total composition). Iso-butyl alcohol can be present in a percentage between 35% and 15%.

In a form of realization of the invention, the composition comprises 50% by weight of the solution referred to in point 10, 25% by weight of Glycerin and 25% by volume of alcohol isobutyl.

According to the applicative purposes the composition can further include a dye and/or an aromatic agent too. The amount of the dye and/or of the aromatic agent within the composition may vary between 0% and 10% of the composition, resulting in proportional and parallel reduction of the percentages of the other components.

Any coloring and flavoring substance known in the state of the art and deemed suitable by the person skilled in the branch for the purposes of this invention may be embodied in the composition described here.

The composition as described above can be prepared using any method considered by the certification of useful for the purpose of this invention. For example, a possible preparation procedure may include a mixture of methylethylketoneperoxide with isobutyl alcohol and then add to the mixture of glycerol. That procedure also could include an additional step of adding the dye and/or the aromatic agent to the mix including MEKP, isobutyl, and glycerol. Mixing can be conducted at room temperature.

The composition of which at the invention may be used as such, in diluted form or with dye and/or flavoring according to the applicative technical requirements, without constituting a new composition.

Use and Method

The use of the composition of the invention for the fixation and/or preservation of organic/biological materials is hereby described.

By the term “fixation and/or preservation of organic tissues”, this patent application refers to the slowing of the chemical and physical deterioration processes that cause a biological material following the removal/expulsion from its physiological environment or of the death of the organism.

For the purposes of the present invention for organic material are meant isolated organs, tissues, cells of animal and vegetable origin. In particular, the use of the composition as described here is in the fixation and/or preservation of organic material of animal and vegetable origin, including: the full body animal, isolated organs, tissues, cells, the plant or parts of it.

Therefore, a subject of the present invention is also a method for the temporarily or perpetually embalming of a deceased animal body comprising a passage of injection into the vascular system of the composition. In addition is the subject of this invention

also the use of the mixture for the antiparasitic treatment and preservation of wood-based materials.

### Experimental Section

The composition of the invention was tested in the laboratory for the conservation and anatomical preparation of organic tissues of animal origin including human tissue. Experiments have shown that the composition described here is characterized by low toxicity and high conservative efficacy.

Tests that have been conducted on tissues, isolated organs and animal corpses in toto and have demonstrated the conservative efficacy of the formulation for over six months.

In this case, the treated parts have been retained over time, at room temperature, shape, volume, elasticity, indicating the absence of putrefactive phenomena.

Tests were performed both by imbibition (immersion of the sample in the solution) and by superficial application (brushing the outer surfaces of the sample), and by forced inoculation of the fluid in the anatomic and vascular cavities.

We treated and examined:

vertebrate animals (36 specimens) found lifeless, by gathering in mountain areas where there were abundant communities of marten, wild boar, crow, mouse, squirrels etc;

invertebrate animals (14 specimens) found lifeless by collecting on mountain roads in the spring;

tissues, organs isolated from human corpses of anatomical-pathological or forensic expertise.

On the basis of the tests carried out the results were even better in the preservation of nucleic acids.

This allows the investigation of “molecular profiling” to also use archive material, allowing to expand the case study.

In addition, the formulation to the study, unlike formaldehyde (and formalin) does not seem to interfere with forensic investigations, in particular toxicological ones, as it reduces the enzymatic activity and does not seem to alter, by chemical reaction, exogenous molecules that may be present in tissues and biological fluids and does not interfere with the determination of ethyl alcohol.

This property allows the use of tissues for judicial purposes even after an eventual embalming or encoffining in case of exhumation and in the case of isolated and preserved organs.

The present invention was so far described with reference to favorite forms of realization. It means that there may be other forms of realization that relate to the same inventive nucleus, as defined by the scope of protection of the claims below.

1-10. (canceled)

11. A method for fixing or preserving organic material comprising contacting the organic material with a non-aqueous liquid composition comprising methyl ethyl ketone peroxide (MEKP).

12. The method according to claim 11, wherein the composition comprises about 30-40% of MEKP by volume.

13. The method according to claim 11, wherein the composition comprises as its main active ingredient a solution comprising about 30-40% MEKP by volume, about 0-5% methyl ethyl ketone, about 0-5% hydrogen peroxide, about 40-50% diisobutrato of 1-Isopropyl-2,2-dimethyltrimethylene, and about 5-10% diacetone alcohol, wherein the main active ingredient is present in the composition at about 30-70% by volume.

14. The method according to claim 11, wherein the composition further comprises glycerin in a proportion between 15-35% by volume.

15. The method according to claim 11, wherein the composition further comprises 15-35% of isobutyl alcohol by volume, a dye, an aromatic agent, or any combination thereof.

16. The method according to claim 11, wherein the composition further comprises glycerin in a proportion between 15-35% by volume, and isobutyl alcohol in a proportion between 15-35% by volume.

17. The method according to claim 11, wherein the organic material is an organ, a tissue, an animal cell, or a vegetable cell.

18. A method for preparing a non-aqueous liquid composition for fixing and/or preserving organic materials comprising mixing a non-aqueous liquid solution comprising methyl ethyl ketone peroxide (MEKP) with isobutyl alcohol and glycerin.

19. The method according to claim 18, wherein the solution further comprises about 30-40% MEKP by volume, about 0-5% methyl ethyl ketone, about 0-5% hydrogen peroxide, about 40-50% diisobutrato of 1-Isopropyl-2,2-dimethyltrimethylene, and about 5-10% diacetone alcohol, wherein the main active ingredient is present in the composition at about 30-70% by volume, wherein the solution is present in the composition at about 30-70% by volume.

20. A non-aqueous liquid composition manufactured by the method according to claim 18.

21. A non-aqueous liquid composition comprising as its main active ingredient a solution comprising about 30-40% methyl ethyl ketone peroxide (MEKP) by volume, about 0-5% methyl ethyl ketone by volume, about 0-5% hydrogen peroxide by volume, about 40-50% diisobutrato of 1-Isopropyl-2,2-dimethyltrimethylene by volume, and about 5-10% diacetone alcohol by volume.

22. A method for perpetually and/or temporarily embalming a dead animal body comprising injecting into blood and/or a lymphatic system a non-aqueous liquid composition according to claim 21.

23. The method according to claim 22, wherein the animal body is a human body.
